(19) United States
(12) Patent Application Publication
(10) Pub. No.: US 2002/0195123 A1
(43) Pub. Date: Dec. 26, 2002

(54) Fiber-optic cable and connector cleaning swab and method

(76) Inventor: David E. Strait, Mahwah, NJ (US)

Correspondence Address: Gregor N. Neff, Esq., c/o Kramer Levin Naftalis & Frankel LLP, 919 Third Avenue, New York, NY, 10022, US

(21) Appl. No.: 09/887,592

(22) Filed: Jun. 22, 2001

(51) Int. Cl. B08B 1/00

(52) U.S. Cl. 134/8; 15/210.1; 15/209.1

(57) ABSTRACT

Very small fiber-optic cable-receiving openings and cable ends within such openings in terminals or connectors are cleaned using a very slender swab comprising multiple layers of a single yarn wound around a very slender form, with end support and/or tension control and yarn size selection and/or balanced simultaneous multiple yarn winding to prevent excessive bending of the slender form during winding.

This invention relates to the cleaning of fiber-optic cables and connectors and to swabs and methods of making swabs for use in such cleaning tasks.

The very small diameter of many fiber optic cables makes the cleaning of connector structures for connecting such cables together very difficult.

Swabs for use in the cleaning task must be very small in diameter in order to fit into the tiny openings in the connectors. This makes the manufacture of the swabs very difficult. Swabs to fit into openings as small as 1.25 mm to 2.5 mm have been developed. One which is known has a tiny knitted sleeve fitted over the end portion of a swab handle. This is believed to be an arduous and expensive task.

Other small swabs use tiny knitted strips wound around the tip of the swab handle to form the swab body. This swab is believed to be very difficult to scale-down for use in cleaning the very small fiber-optic openings to which this invention is directed.

Accordingly, it is an object of the invention to alleviate the foregoing problems and provide a relatively inexpensive method and swab for cleaning fiber-optic connectors and cables.

In accordance with the present invention, the foregoing objects are met by the provision of a method for cleaning fiber-optic cable connectors by winding a single yarn to form multiple layers of yarn on the swab end of a swab form, and inserting the swab into openings in the connectors to clean them.

By winding single strands rather than multiple strands knitted or otherwise, the winding tension can be controlled so as to prevent excessive bending of the very slender and flexible form on which the yarn is wound during winding. The size of the yarn can be selected to ensure the tension is sufficiently low to prevent excessive bending.

If the swab is of the type used to clean only the inner walls of cylindrical holes in the connectors, it need not be covered with yarn at its tip. Thus, the exposed tip can be held to help minimize bending during winding. However, if the tip must be covered, this approach cannot be used.

Alternatively, excessive bending of the swab form can be prevented by simultaneously winding two yarns on the form simultaneously, with the points of application opposite one another. Thus, the tension forces from the two yarn strands can be made equal and opposite to minimize bending of the swab form.

In the winding of the covered-tip swab, preferably the swab form is rotated rapidly while the yarn is applied from a point which moves reciprocatingly in a substantially U-shaped path around the rotating form.

Preferably, the ends of the yarn or yarns forming a swab body are secured to the swab form, as by the use of notches or ultrasonic bonding.

Preferably, the single yarn has a plurality of synthetic fibers, and the yarn is wound at a relatively large pitch angle of approximately 30° and 60° to ensure that the swab has a somewhat loose and soft texture suitable for receiving and holding particles of dust and dirt.

An alternative form of the covered-tip swab is made by winding an uncovered tip swab, bending it double, and securing the bent segments together.

The resulting swab is small enough in diameter to fit into the smallest holes in fiber-optic cable connectors, while being relatively inexpensive to make. Also, it has the desired softness to receive and hold dust and dirt particles, while also being absorbent to liquids. In short, the swab and the process using it are relatively low cost and effective for the desired purposes.

The foregoing and other objects and advantages of the invention are set forth in or evident from the following description and drawings.

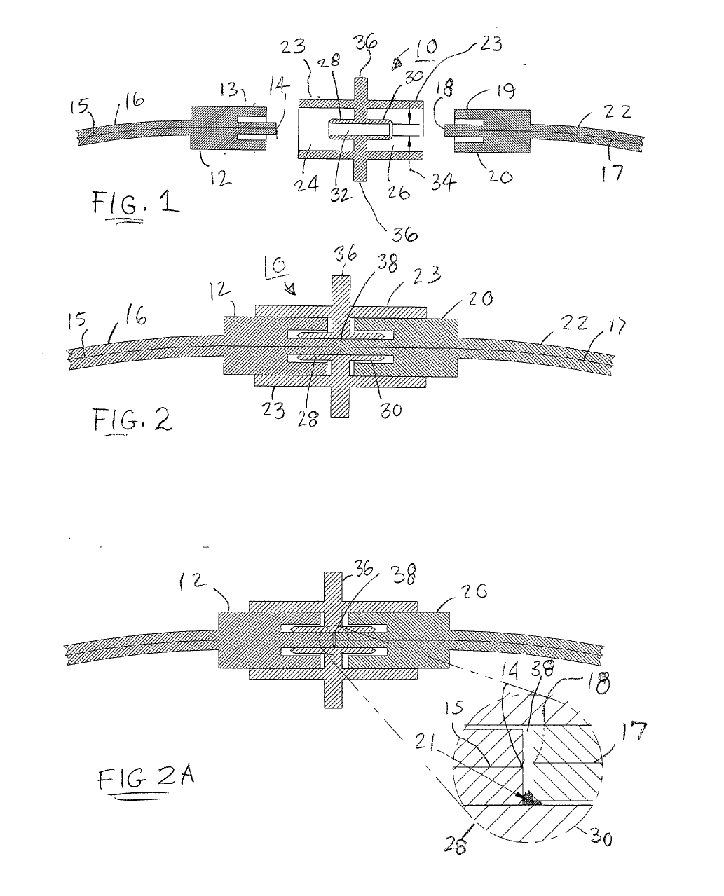

FIGS. 1 and 2 are cross-sectional, partially schematic views of two fiber-optic cables and a connector, the parts being shown separated in FIG. 1 and assembled together in FIG. 2;

FIG. 2A is a view like that of FIG. 2 in which a portion is enlarged to show the deleterious effects of dust or dirt particles on the efficacy of the coupler;

FIG. 3 is a cross-sectional partially schematic view of the connector of FIGS. 1 and 2 with its cable-receiving cylinder being cleaned by an uncovered-tip swab in accordance with the invention;

FIG. 4 is a cross-sectional, partially schematic view of a connector with one cable plugged into it and a covered tip swab being used to clean the end of the one cable and part of the cable-receiving cylinder, in accordance with the invention;

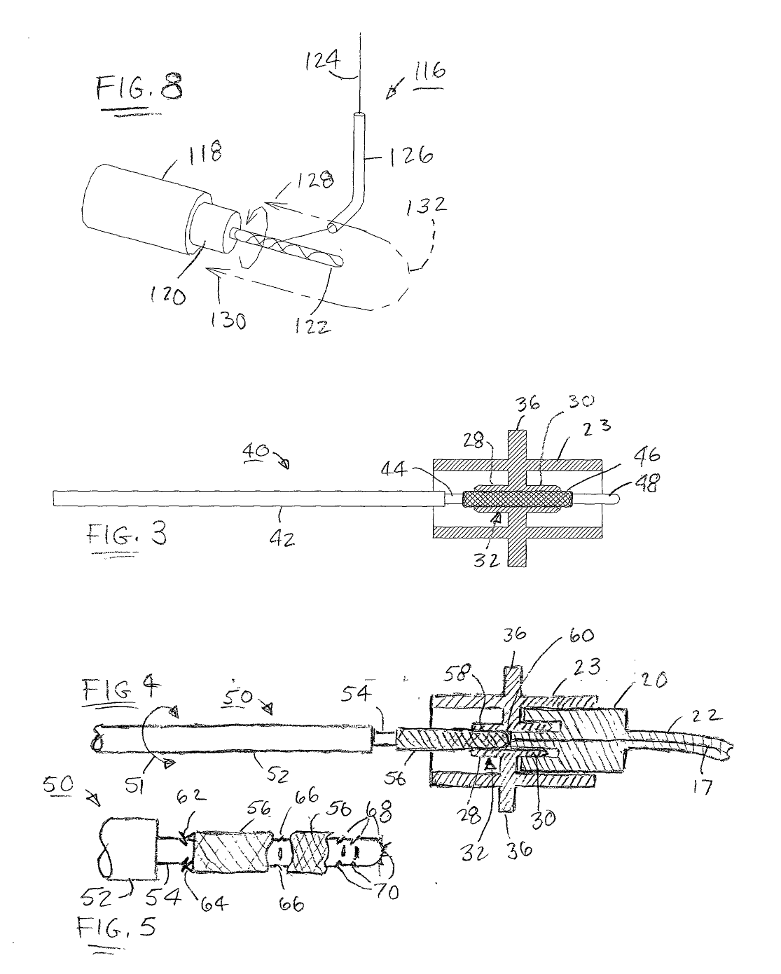

FIG. 5 is an enlarged, partially broken-away view of the swab shown in FIG. 4;

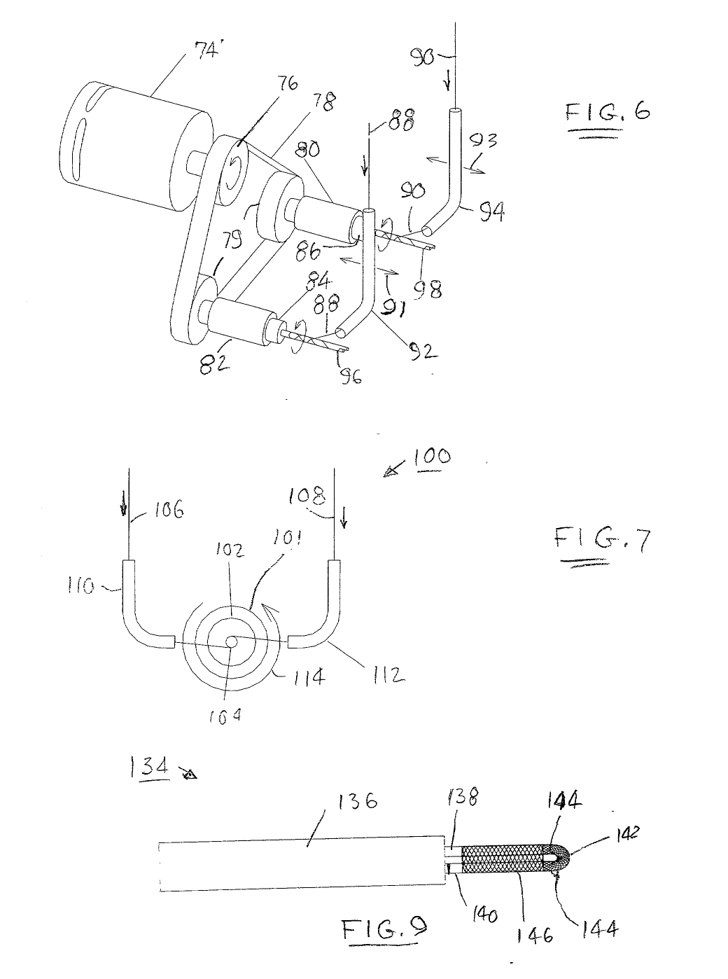

FIG. 6 is a perspective schematic view of a swab winding procedure of the invention;

FIG. 7 is a schematic elevation view of an alternative swab winding procedure of the invention;

FIG. 8 is a perspective view of another swab winding procedure of the invention; and

FIG. 8 is a side elevation view of another embodiment of the swab of the present invention.

### Fiber-Optic Cable Connectors

Fiber-optic cable connectors whose cleaning is the subject of this invention are made in many different forms. FIGS. 1 and 2 illustrate one such connector 10 and the cable termini 12 and 20 which accurately align two fiber-optic conductors 15 and 17 of two different cables 16 and 22 with one another with the flat ends 14 and 18 of the conductors 15 and 17 butted together, as shown at 38 in FIG. 2.

Each terminus 12 and 20 has a hollow cylindrical end portion 13 or 19 which fits into a cylindrical end portion 24 or 26 of the connector. The cable end portion 14 or 18 extends into and beyond the end of each terminus cylinder 13 or 19 along its central axis.

The connector 10 has a central wall 36 supporting a cable end receiving cylinder 32 having a left end 28 and a right end 30, each having a chamfered inlet edge to facilitate accurate entry of the cable ends into the cylinder 32. Typically, the cylinder 32 is made of metal or ceramic material.

When the termini 12 and 20 are plugged into the connector 10, the termini are held firmly in place with the cable end faces firmly abutting one another, thus providing a secure, accurate coupling of the light signals from one conductor to the next.

FIG. 2A is a view like that of FIG. 2 except that it contains an enlarged view of the junction 38 between the cable end faces 14 and 18 when a particle 21 of foreign matter, typically dust or dirt, is present in the cylinder 32. The particle 21 can tilt the cable end 18 upwardly and away from the end 14, thus causing separation and misalignment of the light conductors from one another, thus impairing or even totally disrupting cable communications. Cleaning of particles like the particles 21 from the cylinder is one of the tasks to which this invention is directed.

Another cleaning task to be addressed by this invention is the cleaning of the half 28 or 30 of the cylinder 32, as well as the end 14 or 18 of the cable 16 or 22 when one of the termini 12 or 20 is plugged into the connector but the other is not. This circumstance is shown in FIG. 4, where the terminus 20 is plugged in but the terminus 12 is not. It exists, for example, when one terminus is easily accessible and removable but the other is not.

The problem is that modern fiber-optic cable continues to shrink in diameter as cable designs become more sophisticated. As a result, the inside diameter 34 (FIG. 1) of the cylinder 32 to be cleaned is only 0.125 mm to 0.25 mm, and a swab must be very slender to fit into and clean such openings. This causes substantial manufacturing problems which the invention serves to alleviate.

### Swab Manufacture

in manufacturing swabs small enough to clean the tiny cylinders and cable ends described above, problems arise because the form on which the swab is to be formed must be very slender. Thus, the form bends very easily and knitted strips or other such prior art windings easily can bend the form inordinately and ruin the swab.

In the present invention, this problem is solved or minimized by winding a single fine yarn into several layers of yarn. The tension force on the form then can be set at a very low level to minimize deleterious bending.

FIG. 3 shows a swab 40, made in accordance with the invention, having an uncovered tip.

The swab 40 includes a cylindrical handle 42, a cylindrical swab end portion 44 of smaller diameter, and a cylindrical swab body 46. The tip 48 of the end portion 44 is not covered. The swab form is typically injection molded out of a thermoplastic material such as polypropylene.

The swab 40 is shown with the swab body 46 fitted into the cylinder 32 to clean it. The swab can be moved axially and/or twisted to rub the internal surface of the cylinder 32.

Preferably, the diameter of the swab body 46 is slightly larger than the inside diameter of the cylinder 32 so as to scrub the cylinder wall with some force, and the body 46 is relatively soft so as to readily receive and hold dirt and dust particles to remove them when the swab is withdrawn from the cylinder.

FIG. 4 shows a swab 50 with a covered tip 60, also made in accordance with the invention.

The swab 50 includes a cylindrical handle 52, a cylindrical end portion 54 of reduced diameter, and a cylindrical swab body 56 which covers the tip of the end portion 54, as shown at 60.

The swab 50 cleans the portion of the cylinder 32 which is open, and the covered tip cleans the end of the cable 22 which is located in the cylinder 32. The cable end is cleaned by rotating the swab, as indicated at 51.

FIG. 5 is an enlarged view, partially broken away, of the swab 50. Notches 62 and 64 are provided in the end portion 54 near the handle portion 52. The ends of the yarn forming the swab body are fitted into the notches to secure the ends and prevent the yarn forming the swab body from unraveling. If desired, other means can be used to secure those ends, such as by ultrasonic welding of the ends to the thermoplastic material of the swab form 54 or handle 52, entanglement of the ends in the soft fabric of the swab body, etc.

Further optional notches 66, 68 and 70 are provided, if necessary, to hold the yarn in place during winding.

FIG. 9 snows an alternative construction for a covered-end swab 134. The swab includes a handle portion 136, and a reduced-diameter, elongated end portion 138 with a base tip 140.

The end portion 138 is wound to form a swab body 144 like the swab body 46 in the swab 40 of FIG. 3, except that the body 144 may be longer than the body 46.

Then, the wound swab body 144 and the form 138 are bent double to form a rounded, covered tip 142 for the swab. The bent-double swab body and form are secured together, as by winding yarn 146 around the two bent-together parts. Ultrasonic bonding of the tip 140 to the handle can be used instead of or in addition to the yarn winding 146 to hold the bent parts together with stable dimensions.

### Winding

FIG. 6 shows schematically a system for winding two different swabs 96 and 98 simultaneously. FIG. 6 is a schematic representation of a production machine which would wind many more than two swabs simultaneously, still using only one drive motor 74.

Drive motor 74, through pulleys 76, 79 and belt 78, rotates two (or more) spindles 80, 82 each having a chuck 84 or 86 to hold a swab form 96 or 98.

A single yarn 88 or 90 is supplied from each of two yarn sources (not shown) through a guide tube 92 or 94. Each guide tube 92 or 94 is moved back and forth in the path indicated by reference numerals 91 or 93 by another drive mechanism (not shown) as the spindles 80, 82 are rotating so as to wind the yarn 88 or 90 on the corresponding swab form in a helical pattern.

When enough layers of yarn to produce a swab body of the desired diameter have been wound, the winding is stopped, the yarn is cut and the cut end secured to prevent unraveling.

The finished swabs then are removed from the chucks 84, 86 and new forms inserted into the chucks, the lead ends of the yarns secured, and the process is repeated to make additional swabs.

The yarn used is optional. However, it should be selected to give the desirable properties described above, namely, fineness so as to require only low levels of tension forces, absorptiveness, and thermoplasticity, if heat-welding is to be used to secure the yarn ends to the swab form.

A yarn which has proved to be satisfactory, for at least some uses, is 72 denier, 34 fiber textured polypropylene yarn, which often is used in making knitted clean-room wipers. A wiper body of 84 layers was successfully created using this yarn.

Preferably, the winding pitch angle should be relatively large, e.g., 30 to 60, preferably around 45. This is to create open spaces in the swab body into which particles can fit and will be held.

In general, the movement of the guide tubes is not synchronized with the rotation of the drive spindles so that the starting point of each new layer of winding usually is not the same. Thus, the layers are started at random locations. This produces a smooth and even winding.

It also is preferable that successive layers be increasingly longer than their predecessors so that the ends (or left end, in the case of the covered tip swab 50) do not pile up on one another, thus maintaining a relatively constant diameter for the swab body.

### Multiple Opposed Yarns

FIG. 7 shows a modification of the system of FIG. 6 in which two yarns 106 and 108 are wound on a single swab form 104 held by a chuck 102 rotated by a spindle 101 rotated as indicated by the arrow 114. Each of two guide tubes 110 and 112 supply yarn to the form 104 at locations substantially opposite one another. In this manner, the tension forces applied by the yarns to the form 104 are substantially equal and opposite. This minimizes unwanted flexing of the slender form 104, and offers the choice of increasing the yarn diameter and winding tension if it should be impractical or impossible to use smaller yarn diameters and/or tensions.

### Covered End Swab

FIG. 8 shows another modification of the FIG. 6 system which is used to make covered end swabs.

Instead of moving linearly in a path parallel to the swab form, as shown in FIG. 6, the guide tube 126 moves in a U-shaped path 132 about the swab form 122, in a reciprocating movement which is indicated by the arrows 128 and 130, while the form is rotated by a driven spindle 118 and a chuck 120.

The yarn 124 then is wound over the end of the form 122 to cover it, as well as the body of the form 122.

The equipment used to create the guide tube movements to stop and start the drive motors and to control the functioning of the winding equipment will not be described here because it is well known and readily available for winding small solenoids, transformers and other small wound electrical components. Such equipment is controlled by programmable microprocessors or computers which can be programmed to perform the functions described above.

The above description of the invention is intended to be illustrative and not limiting. Various changes or modifications in the embodiments described may occur to those skilled in the art. These can be made without departing from the spirit or scope of the invention. For example, although the winding of the swabs described herein is done by turning the swab form while dispensing the yarn from a linearly moving point, it is within the scope of this invention to instead use rotary motion of the dispensing point about a stationary swab form to wind the swabs.

1. A method of cleaning fiber-optic cable connectors, said method comprising the steps of:
(a) providing a swab of a diameter small enough to fit into fiber-optic connector openings and clean them;
(b) said swab comprising an elongated support member, said support member having a handle portion and at least one slender, flexible end portion, at least one strand of a single yarn made of a plurality of individual synthetic fibers, said single strand being formed into a plurality of substantially helical layers positioned on top of one another one said end portion to form a wound body, said strand having two ends secured to prevent said strand from unraveling,
(c) inserting said swab into said fiber-optic cable connector opening and cleaning the walls of said opening by moving said swab in said opening.

2. A method as in claim 1 in which an end of a fiber-optic cable is held in said connector and recessed within said opening, said swab having a least one layer of said yarn wound on and covering the tip of said end portion, said cleaning steps including rubbing said tip against said end of said fiber-optic cable.

3. A method as in claim 1 in which said strand is formed into a helical pattern at a predetermined pitch angle with each layer having a starting location and an ending location, the starting location of some of said layers being spaced circumferentially from the starting location of a layer preceding it.

4. A method as in claim 1 in which said providing step comprises winding said single strand around said end portion repeatedly in a reciprocating path and controlling the tension on said yarn so as to minimize bending of said end portion under said tension.

5. A method as in claim 4 including the step of selecting a yarn size small enough to allow the tension applied to it to be set at a level minimizing ending of said end portion.

6. A method as in claim 1 including winding said strand on said end portion under tension, controlling said tension so as to create a desired degree of softness in the finished swab, and selecting the yarn size to enable the tension to be set at a value low enough to keep bending of said end portion at a minimum during winding.

7. A method as in claim 1 in which said providing step comprises winding said single strand around said end portion repeatedly in a reciprocating path and holding said end portion at its tip to minimize bending of said end portion.

8. A method of making a swab for cleaning very small openings, said method comprising the steps of:
(a)providing an elongated support member with a slender flexible end portion;
(b) winding at least one strand of multi-filament yarn upon said end portion in a helical pattern to form a plurality of layers of yarn, said layers covering a substantial portion of said end portion; and
(c) securing the ends of said strand to hold said yarn against unraveling.

9. A method as in claim 8 in which said yarn is wound under tension, and including the step of setting said tension at a value to reduce bending of said end portion during winding.

10. A method as in claim 9 including controlling said tension so as to create a desired degree of softness in the finished swab, and selecting the yarn size to enable the tension to be set at a value low enough to keep bending of said end portion at a minimum during winding.

11. A method as in claim 8 in which said yarn is wound under tension and holding said end portion at its tip to minimize bending of said end portion.

12. A method as in claim 8 including the step of substantially simultaneously winding a second strand of yarn upon said end portion, applying tension to each of said strands and positioning said strands so that the tension forces applied to said end portion are opposed to one another to reduce the force tending to bend said end portion.

13. A method as in claim 12 in which the points of application of said tension forces are substantially opposite one another and said tension forces are substantially equal to one another.

14. A method as in claim 8 in which said layers cover the outer tip of said end portion, and said winding step includes moving the point of application of said yarn around said tip to cover it.

15. A method as in claim 14 in which said point of application reciprocates in a generally U-shaped pattern around said end portion.

16. A method as in claim 8 including bending said end portion double after said winding step to form a swab with a covered tip.

17. A method as in claim 16 including winding a yarn around the doubled-up end portion to secure the bent parts in place.

18. A swab, said swab comprising, in combination:
an elongated support member, said support member having a handle portion and at least one slender, flexible end portion,
at least one strand of a single yarn made of a plurality of individual synthetic fibers, said single strand being formed into a plurality of substantially helical layers positioned on top of one another on said end portion to form a wound body,
said strand having two ends secured to prevent said strand from unraveling.

19. A swab as in claim 18 in which said strand is formed into a helical pattern at a predetermined pitch angle with each layer having a starting location and an ending location, the starting location of some of said layers being spaced circumferentially from the starting location of a layer preceding it, said pitch angle being between 30 and 60.

20. A swab as in claim 18 in which said swab end portion has notches in its surface to hold said strand in place when wound on said surface.

21. A swab as in claim 18 in which said swab end portion has a tip which is round and each course of said yarn strand extends over said round tip.

22. A swab as in claim 21 in which said round tip has striations to help hold said strand in place.

23. A swab as in claim 18 in which said swab end portion is bent double upon itself to form a swab tip which is round and is substantially covered with at least one layer of yarn.

24. A swab as in claim 23 in which said double bent end portion is covered with at least one layer of wound yarn binding the bent portion together.

25. A swab as in claim 18 in which said yarn is textured and is selected from the group consisting of nylon and polypropylene.

26. A swab as in claim 18 in which said yarn is approximately 70 denier, 34 filaments.
